(19) United States
(12) Patent Application Publication
(10) Pub. No.: US 2024/0068174 A1
(43) Pub. Date: Feb. 29, 2024

(54) PRODUCTION PROCESS OF A GRANULAR INFILL MATERIAL AND RELATED GRANULAR INFILL MATERIAL

(71) Applicant: POLYGREEN SRL, DESENZANO DEL GARDA (IT)

(72) Inventor: Roberto DIAN, DESENZANO DEL GARDA (IT)

(21) Appl. No.: 18/259,846

(22) PCT Filed: Dec. 16, 2021
(86) PCT No.: PCT/IT2021/050417

§ 371 Date: Jun. 29, 2023

(30) Foreign Application Priority Data
Jan. 4, 2021 (IT) 102021000000038

(51) Int. Cl. E01C 13/08; C08J 9/00; C08J 9/08; C08J 9/18; C08K 3/26

(52) U.S. Cl. CPC E01C 13/08; C08J 9/0004; C08J 9/0066; C08J 9/08; C08J 9/18; C08K 3/26; C08J 2327/06; C08J 2375/04; C08J 2497/02; C08K 2003/265

(57) ABSTRACT

Production process of a granular infill material (402) for a synthetic turf surface (400), the process comprising: —providing a granular semi-finished product (2) in form of raw granules; —preparing a polymeric blend (3) comprising a polymeric material and a blowing agent; —coating the raw granules (2) with the polymeric blend (3); —subsequently, drying the polymeric blend (3) to obtain the granular infill material (402) comprising a plurality of granules (200), each one comprising a core comprising one or more of the raw granules and a polymeric coating of the core comprising the polymeric blend (3).

### TECHNICAL FIELD OF THE INVENTION

The present invention relates to a production process of a granular infill material for synthetic turf mat and to a granular infill material.

### STATE OF THE ART

In the making of surfaces for sports use (e.g., soccer fields, football fields, rugby fields, baseball fields, etc.) and/or for decorative use (e.g., gardens), a rigid and compact substrate (e.g., in clay or asphalt) is typically prepared onto which a synthetic turf mat, i.e., a mat comprising artificial fibres simulating the natural grass, is laid. In addition, a layer of granular material, called infill (which can be made of various materials such as rubber granules, even recycled rubber granules, sand, cork and/or coconut, etc.), is typically spread onto the synthetic turf mat between the artificial fibres. The infill structurally stabilizes the synthetic turf mat and/or improves its aesthetic quality, making it look more likely to the natural grass (as it facilitates the upright position of the artificial fibres) and/or improves its use for sports, improving its performance properties (for example in terms of mechanical response of the mat, rolling/bouncing of the ball, etc.).

WO2008053389A1 discloses a granular infill material wherein the single granule has a core deriving from natural material (e.g., cork), coated with a polyurethane or silicone polymer.

EP2206833A1 discloses a granular infill material wherein the single granule comprises a thermoplastic matrix and a coco-based filler.

WO2006109110A1 discloses a granular infill material comprising granules deriving from plant material in fibrous form (e.g., coconut, agave, hemp) which are mixed with sand and optionally granules of artificial rubber or natural rubber.

US2015252537A1 discloses an infill material comprising a mixture of rachis of corn cob, a lignin vegetable component (among which olive pits, pine pits, pine cones, parts of banana peel or other fruit), and optionally sand or cereal shells/husks.

WO2016205087A1 discloses a granular infill material comprising a thermoplastic matrix (e.g., PVC, PE, PET, PP) and a cellulose-based filler (e.g., derived from soft wood, hard wood, walnut shells, pecan nut shells, peanuts shells, coconut shells).

### SUMMARY OF THE INVENTION

The Applicant has considered that the known granular infill materials have some drawbacks and/or can be improved in certain aspects.

The Applicant has observed that if the granular infill material has an insufficient water retention degree, there may be a risk of overheating of the synthetic tur mat (for example due to sun irradiation) and/or an increase in the waste of sprayed water. If, on the other hand, the granular infill material has an excessive water retention degree, the granular infill material tends to soften, with possible consequent rapid damage. In both situations, damages of the granular infill material and/or of the synthetic turf mat and/or decreases in comfort for the users may occur. For example, WO2008053389A1 discloses a granular infill material comprising cork which according to the Applicant has insufficient hygroscopic (i.e., ability to absorb humidity present in the air) and/or hydrophilic (i.e., ability to absorb water in liquid form, e.g., rain or actively sprayed on the mat) properties, while EP2206833A1 discloses a granular infill material comprising coconut which instead has excessive hygroscopic (i.e., ability to absorb humidity present in the air) and/or hydrophilic properties.

The Applicant has observed that the granular infill materials disclosed in WO2006109110A1 and US2015252537A1 do not have a polymeric component and therefore the plant material is placed directly in contact with the synthetic turf surface and directly exposed to natural agents. According to the Applicant, the intrinsic features of the plant materials used may be inadequate to provide the desired performance properties to the granular infill material and/or to the synthetic turf surface.

For example, if plant materials with high hardness are used (such as disclosed in US2015252537A1), there may be a rapid and/or accentuated damage to the synthetic surface (in particular the mat) and/or a high injury risk for the users of the mat (typically in the event of falls and/or slips), due to the high abrasiveness of the granular infill material.

Conversely, if soft and/or flaky plant materials are used (such as disclosed in WO2006109110A1), a high and/or rapid dimensional deformation and/or a shattering (e.g., typically a crushing and/or a pulverization) of the granules may occur when the granular infill material is subjected to normal trampling action during use of the synthetic turf mat. This deformation of the granules results in an increase in the wear of the surface of the synthetic turf mat (e.g., since the crushing involves a decrease in the volume of the granules and consequently a greater portion of the artificial fibers which is left free and subjected to wear during use of the surface) and/or a loss of performance properties of the granular infill material, such as the ability to efficiently cushion the stresses to which the mat is subjected during use (causing for example a decrease in comfort for users and/or an increase in the injury risk, typically joint injuries) and/or a decrease in the comfort of use of the surface (worsening of the bounce/rolling of the ball).

Furthermore, the intrinsic hydrophilic and/or hygroscopic properties of the particular plant material used may be unsuitable for providing the desired water retention degree to the granular infill material, leading to the aforesaid problems of overheating of the surface (and possible consequent damage) and/or of rapid damage of the granular infill material.

The Applicant has therefore faced the problem of making a granular infill material, which is endowed with the desired performance properties, for example in terms of surface hardness, dimensional stability and/or water retention.

According to the Applicant, the aforesaid problem is solved by a production process of granular infill material and a relative granular infill material according to the attached claims and/or having one or more of the following features.

According to an aspect the invention relates to a production process of a granular infill material for a synthetic turf surface, the process comprising:
providing a granular semi-finished product in form of raw granules;
preparing a polymeric blend comprising a polymeric material and a blowing agent;
coating said raw granules with said polymeric blend;
subsequently, drying said polymeric blend to obtain said granular infill material comprising a plurality of granules, each one comprising a core comprising one or more of said raw granules and a polymeric coating of said core comprising said polymeric blend.

According to an aspect the invention relates to a granular infill material for a synthetic turf surface, said granular infill material comprising a plurality of granules, each one comprising a core comprising one or more raw granules of a granular semi-finished product and a polymeric coating of said core comprising a polymeric blend.

Preferably said polymeric blend comprises a polymeric material and a blowing agent. The Applicant has discovered that the use of a blowing agent in the polymeric blend allows to obtain a polymeric coating of the core having a “sponge-like” structure. The Applicant, without restricting to any theory, has discovered that, typically during the drying of the polymeric blend which make up (or contributes to make up) the polymeric coating of the core, a blowing reaction of the blowing agent takes place which determines the formation of micro-bubbles inside the polymeric blend. These micro-bubbles lead to the formation of a porosity throughout the volume of the polymeric coating, which assumes the aforesaid sponge-like structure. Furthermore, during the drying of the polymeric blend, the solidification of the polymeric blend (e.g., linked to a crosslinking reaction) also occurs at the same time as the blowing reaction, which forms the coating of the core, thus allowing the stabilization of the sponge-like structure which is forming.

According to the Applicant, the sponge-like structure of the polymeric coating allows to give to the granular infill material with a double advantageous effect.

Firstly, the Applicant has observed that the sponge-like structure allows to mitigate any abrasive properties of the core (e.g., when a hard/rigid material core is used) and/or improve the durability of the core (e.g., in case very soft or not resistant core). The Applicant has in fact realized that the polymeric coating thus obtained allows to give a predetermined (and desired) structural hardness and/or stiffness to the granular infill material, which is independent on the type of material of the granular semi-finished product. In fact, the polymeric coating acts as a cushion/shock absorber if the core is made of hard/rigid material, while it acts as a stiffening element if the core is made of soft/flaky material. In this way, it is possible to provide the granular infill material with adequate properties both in terms of abrasiveness and dimensional stability, limiting the damage of the synthetic surface (in particular the synthetic turf mat) and/or providing the appropriate performance properties to the synthetic surface and/or to the granular infill material (e.g., cushioning ability, ball rolling/bouncing, and/or comfort for athletes) and/or extending the operative life of the synthetic surface and/or of the granular infill material.

Secondly, the Applicant has observed that the sponge-like structure allows to stabilize the water retention degree of the granular infill material, since the polymeric coating has a surface porosity (given by the aforesaid sponge-like structure) which allows the retention of a determined quantity of micro-drops of water, e.g., rain and/or actively sprayed on the synthetic turf surface. In this way it is possible to confer a homogeneous and appropriate water retention degree to the granular infill material, regardless of the hygroscopic and/or hydrophilic properties of the material of which the core is made. This is particularly advantageous in order to limit, or avoid, overheating (and consequent damage) of the synthetic turf surface (e.g., linked to poor hygroscopic/hydrophilic properties of the core), with also saving of sprayed water, and/or damage of the granular infill material (e.g., linked to excessive hygroscopic/hydrophilic properties of the core, which lead to its structural weakening). The present invention in one or more the aforesaid aspects can have one or more of the following preferred features.

Preferably said providing said granular semi-finished product comprises providing raw waste and grinding said raw waste to obtain said granular semi-finished product.

In one embodiment said providing said granular semi-finished product comprises micronizing said raw waste, wherein said raw granules preferably have dimensions less than or equal to 0.4 mm, more preferably less than or equal to 0.3 mm, even more preferably less than or equal to 0.2 mm.

Preferably said granular semi-finished product (or said raw waste) is (are) (at least partially) made of plant material, more preferably is (at least partially) a mixture of various plant materials. Preferably said plant material (or said plant materials in case of said mixture) is selected in the group: olive pits, pine cones, coconut fiber/peat, cork, rice husk, banana fiber/peat, lignin, cellulose, wood sawdust, tree defibration, hemp, or combinations thereof. In this way, the cost of the granular infill material is limited and easily disposable materials are used, reducing the environmental impact in terms of pollution. The Applicant has in fact observed that it is advantageously possible to use a granular semi-finished product comprising a heterogeneous mixture of plant materials, since the performance properties of the granule in terms of abrasiveness, structural stability and/or water retention are (substantially) conferred by the polymeric coating and they are not (significantly) related to the particular properties of the materials making up the core.

In one embodiment said raw waste (at least partially) derive from waste of one or more between: wallpaper, tyres, imitation leather, or combinations thereof. In this way, materials that are readily available at low cost are used since they are waste products which can be recycled also favouring a circular economy.

Preferably said polymeric material comprises (or consists of) a polymeric resin of vegetable origin, more preferably selected in the group: linen-based polymeric resins, corn-based polymeric resins, oleoresins, turpentine resins (e.g., rosin), conifers polymeric resins (e.g., larch, stone pine, Aleppo pine or sylvestris pine), gluten-based polymeric resins (e.g., flour, starch, rice and/or wheat), polyurethane resins of vegetable origin (e.g., obtained from poly-oils of vegetable origin such as soybeans, castor oil, turnips), or combinations thereof. In this way it is used an ecological material which is easily processable to obtain the polymeric blend.

In one particularly preferred embodiment said polymeric material is a polyurethane resins of vegetable origin.

In one embodiment said polymeric material comprises (or consists of) a polymeric resin selected in the group: polyurethane (PU), polyvinyl chloride (PVC), polyethylene (PE), e.g., high density polyethylene (HDPE), polyester, e.g., polyethylene terephthalate (PET), polypropylene, EVA, or combinations thereof. In this way it is possible to simply and low-costly make the polymeric blend using easily available materials.

Preferably said blowing agent is selected in the group: hydrocarbons (e.g., pentane, isopentane, cyclopentane), liquid carbon dioxide, isocyanates, azo-amides (e.g., azodicarbonamide), hydrazine (e.g., benzene sulfonyl-hydrazide, 5-phenyltetrazole), sodium bicarbonate, citric acid, or combinations thereof. In this way, it is used a blowing agent readily available on the market and capable of allowing an effective/efficient expansion reaction in combination with the aforesaid polymeric materials.

Preferably said polymeric blend comprises water or one or more, preferably organic (e.g., white petroleum and/or white spirit), liquid solvents for obtaining respectively an aqueous emulsion and a solvent emulsion of said polymeric material and said blowing agent. In this way it is possible to simply coat said granular semi-finished product with the polymeric blend.

Preferably said polymeric blend comprises an amount of said blowing agent greater than or equal to 20 g, more preferably greater than or equal to 25 g, even more preferably greater than or equal to 30 g, and/or less than or equal to 100 g, more preferably less than or equal to 80 g, even more preferably less than or equal to 50 g, for each kg of said polymeric material. In this way it is possible simply and effectively obtaining the sponge-like structure of the polymeric coating. Furthermore, the Applicant has realized that by varying the amount of blowing agent within the above-described ranges, it is possible to modulate the porosity of the polymeric coating, obtaining a granular infill material that can meet different performance standards (e.g., CONI, UEFA or FIFA), using the same type of granular semi-finished product and/or of polymeric material. In this way, the costs and/or times of the production process of the granular infill material are reduced and/or it is possible to simplify the industrial apparatus used to implement the production process.

Preferably said polymeric blend comprises a reinforcing filler. Preferably said reinforcing filler is a mineral material, more preferably selected in the group: calcium carbonate, talc, kaolin, sand, lime, or combinations thereof.

In one particularly preferred embodiment said reinforcing filler is calcium carbonate. Preferably an amount of said reinforcing filler is greater than or equal to 15%, more preferably greater than or equal to 20%, even more preferably greater than or equal to 25%, and/or less than or equal to 40%, more preferably less than or equal to 35%, even more preferably less than or equal to 30%, of an overall weight of said polymeric blend.

In this way, according to the Applicant, it is possible to further improve the properties of dimensional stability of the granular infill material and to limit the production costs given the low costs of the mineral materials used as reinforcing filler.

Preferably said polymeric blend comprises one or more additives, preferably selected among flame retardants, anti-oxidants, anti-UV rays and/or dyes. In this way it is possible to simply provide particular properties to the granular infill material.

Preferably said coating said raw granules comprises:
positioning said raw granules inside a coating chamber;
suspending in air said raw granules inside said coating chamber, preferably by a jet of gas (e.g., compressed air) or by mechanical means;
spraying said polymeric blend onto said raw granules in suspension.

In this way, according to the Applicant, it is possible to simply and homogeneously coat the raw granules of the granular semi-finished product since the polymeric blend is suitable for being sprayed, in particular when in the form of emulsion.

In one embodiment said drying said polymeric blend comprises applying a temperature greater than or equal to 60° C., more preferably greater than or equal to 70° C., and less than or equal to 100° C., more preferably less than or equal to 90° C., for a time interval greater than or equal to 30 s, more preferably greater than or equal to 50 s, and less than or equal to 80 s, more preferably less than or equal to 70 s. In this way it is possible to allow a rapid drying of the polymeric blend and to promote the crosslinking of the polymeric blend through the application of heat, which acts as a physical crosslinking agent.

In one embodiment said drying said polymeric blend is carried out at room temperature for a time interval greater than or equal to 80 s, more preferably greater than or equal to 100 s, and less than or equal to 200 s, more preferably less than or equal to 180 s. In this way it is possible to provide the appropriate crosslinking degree of the polymeric blend without the need to have to provide for further industrial machinery that would increase the production costs.

Preferably said polymeric coating has a weight percentage greater than or equal to 5%, more preferably greater than equal to 8%, and less than or equal to 18%, more preferably less than or equal to 15%, of an overall weight of said granule.

Preferably said polymeric coating has an average thickness (considered on the whole granule and for a wide granule statistic) greater than or equal to 0.1 mm, more preferably greater than or equal to 0.2 mm, and/or less than or equal to 0.5 mm, more preferably less than or equal to 0.4 mm.

In this way it is possible to provide a polymeric coating which provides the desired performance properties, without excessively increasing the overall weight of the granular infill material. In this way, given the high quantities (typically tons) of granular infill material needed for creating a synthetic turf surface, it is in fact possible to keep ergonomic and/or simple the transport of the granular infill material as well as its application on the synthetic surface.

According to a further aspect the invention relates to a synthetic turf surface comprising said synthetic turf mat and a layer of said granular infill material according to any embodiment of the present invention arranged above said synthetic turf mat. In this way, the desired performance and/or aesthetic properties are provided to the synthetic turf surface, and in particular to the synthetic turf mat, in terms, for example, of wear resistance and/or low abrasion risk for users and/or adherence for users and/or likelihood to the natural grass.

Preferably said layer of granular infill material has a mass per unit area greater than or equal to 3 kg/m², more preferably greater than or equal to 8 kg/m², and/or less than or equal to 20 kg/m², more preferably less than or equal to 10 kg/m². In this way, it is provided the appropriate amount of granular infill material for providing the desired performance/aesthetic properties.

### BRIEF DESCRIPTION OF THE DRAWINGS

FIG. 1 schematically shows in vertical section a synthetic turf surface comprising a layer of granular infill material according to the present invention;

FIG. 2 shows a block diagram of a production process of a granular infill material according to the present invention.

### DETAILED DESCRIPTION OF SOME EMBODIMENTS OF THE PRESENT INVENTION

The features and advantages of the present invention will be further clarified by the following detailed description of some embodiments, presented by way of non-limiting example of the present invention, with reference to the attached figures.

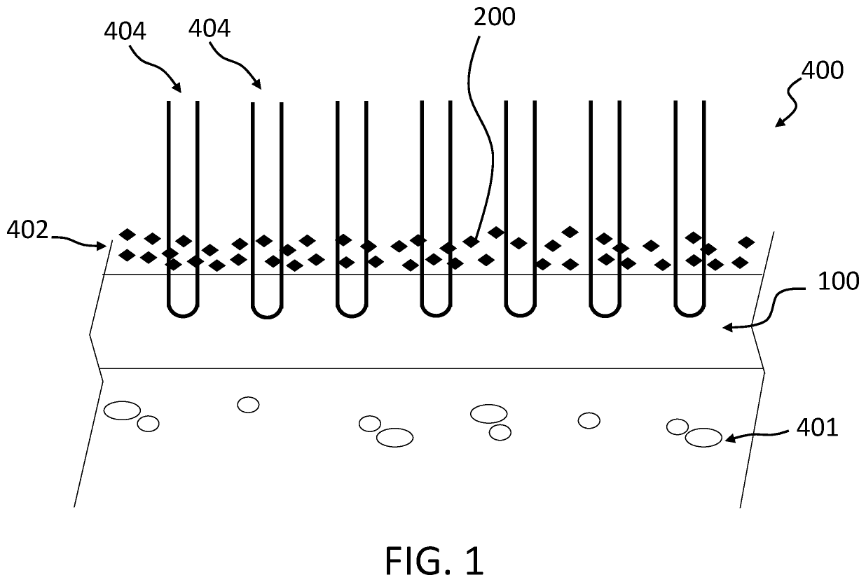

With reference to FIG. 1, it is schematically shown a synthetic turf surface 400 comprising a compact substrate 401 (for example in clay as known), onto which a synthetic turf mat 100 is laid, not further disclosed as for example of a known type, and at least one layer of granular infill material 402 (comprising a plurality of granules 200) arranged above the synthetic turf mat 100 between the artificial fibers 404 of the mat 100 (which simulate grass threads). Exemplarily the layer of granular infill material 402 has a mass per unit area equal to about 8 kg/m². In some embodiments, two or more superimposed layers of granular material of different composition are provided. Typically, the granular material of the present invention is a performance infill and therefore is located at the top of the infill.

The synthetic turf surface 400 is not further disclosed and illustrated as known per se. Preferably each granule 200 comprises a core comprising one or more raw granules of a granular semi-finished product and a polymeric coating of the core comprising a polymeric blend, which comprises a polymeric material and a blowing agent.

Exemplarily the polymeric coating of each granule 200 has a weight percentage equal to about 10-12% of an overall weight of the granule, and typically the average thickness of the polymeric coating is equal to about 0.2-0.3 mm.

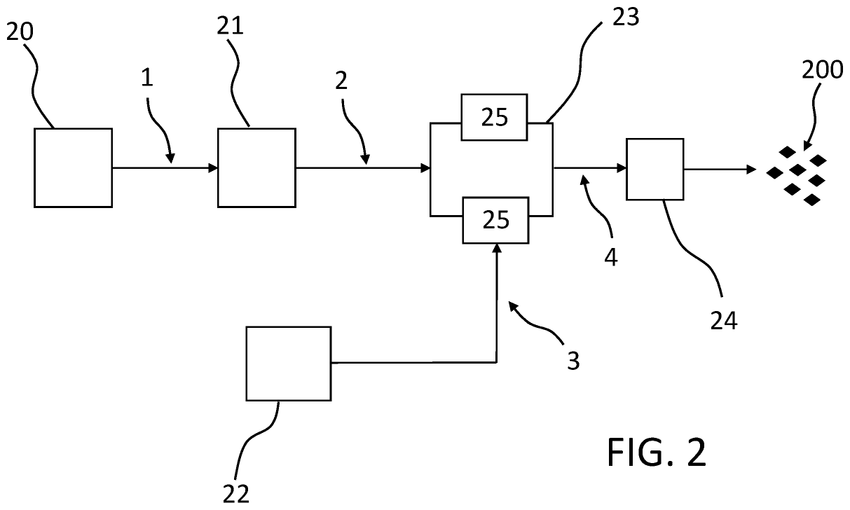

With reference to FIG. 2, reference number 20 schematically indicates a container for collecting raw waste 1, for example waste of plant components.

In one embodiment the raw scraps 1 comprise (or consist of) scraps of composite materials (such as imitation leather and/or wallpaper) and/or scraps of tyres.

After collection, the process comprises grinding the raw waste 1 to obtain a granular semi-finished product 2 in the form of raw granules. The grinding is exemplarily carried out by feeding the raw waste 1 to one or more grinding mills 21 (only schematically shown) in which, for example, there is a respective blades and counter-blades system (for example of a known type). For example, the grinding can comprise a coarse pre-grinding of the raw waste 1 and a subsequent micronation to obtain the granular semi-finished product 2 in the form of raw granules having dimensions equal to about 0.2 mm. The grinding operation of the raw waste 1 is not further described as for example of known type.

Once the grinding of the granular semi-finished product is finished, the latter is conveyed inside a coating chamber 23 which comprise blower elements (not shown) able to emit a jet of compressed air.

Simultaneously or in series with the preparation and grinding of the raw waste 1, the process comprises preparing a polymeric blend 3 comprising a polymeric material and a blowing agent. Exemplarily the preparation of the polymeric blend 3 is carried out inside special mixing devices 22 (only schematically shown and for example of known type) in which a respective amount of polymeric material, blowing agent and water are conveyed to obtain the polymeric blend 3 in the form of an aqueous emulsion.

In one embodiment the preparation of the polymeric blend 3 comprises adding to the polymeric material an amount of reinforcing filler, exemplarily in powder form.

In one embodiment the preparation of the polymeric blend 3 comprises adding to the polymeric material flame-retardant additives, anti-oxidant additives, anti-UV rays additives, and/or dyes.

Once the preparation of the polymeric blend 3 is completed inside the mixing device 22, the polymeric blend 3 is fed to spraying devices 25 arranged along the perimeter of the coating chamber 23, and each one comprising a plurality of (for example from 5 to 10) spraying nozzles facing the internal volume of the coating chamber 23.

At this point, the process comprises operating the blower elements present in the coating chamber 23 to generate a jet of compressed air which suspends in air the granular semi-finished product 3 inside the coating chamber 23, and to spray through the spraying devices 25 the polymeric blend 3 onto the granular semi-finished product 3 (i.e., on the outer surface of the single raw granules or on the outer surface of conglomerates of raw granule, typically in a maximum number of 3-5 granules) so as to completely and homogeneously coat the granular semi-finished product 3.

Once the coating step of the granular semi-finished product 3 has been completed, the coated granular semi-finished product 4 is conveyed by a conveyor belt (not shown) to a drying station 24 exemplarily comprising an oven thermostated at a temperature of 80° C. The drying of the coated granular semi-finished product 4 exemplarily takes place in a time interval of about 1 minute inside the oven to obtain the granules 200 once the drying phase is finished.

In one embodiment the drying of the coated granular semi-finished product 4 is carried out by leaving the coated granular semi-finished product 4 on the conveyor belt at room temperature for a time interval of about 2 minutes.

Optionally, the granules 200 thus obtained can be subsequently fed into a sieving device (for example a vibrating screen with superimposed sieves in which there are a plurality of openings having different sizes) which allows the subdivision of the granules 200 according to the granulometry. The average size of the granules ranges from about 2 mm to 5 mm.

In the following, some examples of processes for producing the granules 200 according to the present invention are described.

### Example 1

Composition of the raw waste 1: 100% plant material, 80% olive pits and 20% cork;
Polymeric material: polyurethane resin of vegetable origin;
Blowing agent: sodium bicarbonate;
Amount of blowing agent/kg of polymeric material: 40 g
Reinforcing filler: calcium carbonate;
Additives: anti UV rays, flame retardants and dyes.

### Example 2

Composition of the raw waste 1: 80% plant material, of which 70% olive pits and 30%
coconut peat, and 20% waste of tyres;
Polymeric material: polyurethane resin of vegetable origin;
Blowing agent: sodium bicarbonate;
Amount of blowing agent/kg of polymeric material: 45 g
Reinforcing filler: calcium carbonate;
Additives: anti UV rays, flame retardants and dyes.

### Example 3

Composition of the raw waste 1: 100% plant material, of which 30% olive pits, 30% coconut peat, 20% pine cones and 20% lignin;
Polymeric material: 50% polyurethane resin of vegetable origin, 50% polyvinyl chloride resin;
Blowing agent: sodium bicarbonate;
Amount of blowing agent/kg of polymeric material: 35 g
Reinforcing filler: calcium carbonate;
Additives: anti UV rays, flame retardants and dyes.

1. A production process of a granular infill material for a synthetic turf surface, the process comprising:
providing a granular semi-finished product in form of raw granules;
preparing a polymeric blend comprising a polymeric material and a blowing agent;
coating said raw granules with said polymeric blend;
subsequently, drying said polymeric blend to obtain said granular infill material comprising a plurality of granules, each one comprising a core comprising one or more of said raw granules and a polymeric coating of said core comprising said polymeric blend.

2. The process according to claim 1, wherein said blowing agent is selected in the group: hydrocarbons, liquid carbon dioxide, isocyanates, azo-amides, hydrazines, sodium bicarbonate, citric acid, or combinations thereof.

3. The process according to claim 1, wherein said providing said granular semi-finished product comprises providing raw waste and grinding said raw waste to obtain said granular semi-finished product, and wherein said raw waste are made of plant material selected in the group: olive pits, pine cones, coconut fiber/peat, cork, rice husk, banana fiber/peat, lignin, cellulose, wood sawdust, tree defibration, hemp, or combinations thereof.

4. The process according to claim 1, wherein said polymeric material comprises a polymeric resin of vegetable origin selected in the group: linen-based polymeric resins, corn-based polymeric resins, oleoresins, turpentine resins, conifers polymeric resins, gluten-based polymeric resins, polyurethane resins of vegetable origin, or combinations thereof.

5. The process according to claim 1, wherein said polymeric blend comprises an amount of said blowing agent greater than or equal to 20 g and/or less than or equal to 100 g for each kg of said polymeric material.

6. The process according to claim 1, wherein said polymeric blend comprises:
a reinforcing filler which is a mineral material selected in the group: calcium carbonate, talc, kaolin, sand, lime, or combinations thereof, wherein an amount of said reinforcing filler is greater than or equal to 15% and/or less than or equal to 40% of an overall weight of said polymeric blend;
one or more additives selected among flame retardants, anti-oxidants, anti-UV rays and/or dyes, and
wherein said drying said polymeric blend comprises applying a temperature greater than or equal to 60° C. and less than or equal to 100° C. for a time interval greater than or equal to 30 s and less than or equal to 80 s.

7. The process according to claim 1, wherein said coating said raw granules comprises:
positioning said raw granules inside a coating chamber;
suspending in air said raw granules inside said coating chamber;
spraying said polymeric blend onto said raw granules in suspension.

8. Granular infill material for a synthetic turf surface, said granular infill material comprising a plurality of granules, each one comprising a core comprising one or more raw granules of a granular semi-finished product and a polymeric coating of said core comprising a polymeric blend, wherein said polymeric blend comprises a polymeric material and a blowing agent.

9. The material according to claim 8, wherein said polymeric coating has a weight percentage greater than or equal to 5% and less than or equal to 18% of an overall weight of said granule, and wherein said polymeric coating has an average thickness greater than or equal to 0.1 mm and/or less than or equal to 0.5 mm.

10. Synthetic A synthetic turf surface comprising a synthetic turf mat and a layer of a granular infill material according to claim 8 arranged above said synthetic turf mat, and wherein said layer of granular infill material has a mass per unit area greater than or equal to 3 kg/m² and/or less than or equal to 20 kg/m².
